(19) United States
(12) Patent Application Publication
(10) Pub. No.: US 2008/0000515 A1
(43) Pub. Date: Jan. 3, 2008

(54) Automatically Solar Energy Tracking and Collecting System

(76) Inventors: Kuo-Len Lin, Wugu Township (TW); Ken Hsu, Wugu Township (TW); Wen-Jung Liu, Wugu Township (TW); Hai-Rui Ye, Wugu Township (TW)

Correspondence Address: HDSL, 4331 STEVENS BATTLE LANE, FAIRFAX, VA, 22033, US

(21) Appl. No.: 11/428,371

(22) Filed: Jun. 30, 2006

(51) Int. Cl. H02N 6/00; G01J 1/20

(52) U.S. Cl. 136/246; 250/203.4

(57) ABSTRACT

An automatically solar energy tracking and collecting system includes a solar energy concentrator and a pedestal for supporting and locating the solar energy concentrator. The pedestal has at least one universal joint connecting with the solar energy concentrator, at least one supporting shaft engaging with the universal at least one joint, at least one photo sensor for detecting the direction and position of sunbeams and a pump driving the at least one supporting shaft to expand or contract according to the detecting signal from the at least one photo sensor. The at least one supporting shaft cooperates with the at least one universal joint to adjust the position and angle of the solar energy concentrator relative to a predetermined reference surface.

### BACKGROUND

The present invention relates to an automatically solar energy tracking and collecting system, and more particularly to an automatically solar energy tracking and collecting system in which a solar energy concentrator, sensitive to solar radiation, is oriented to face the sun and to change orientation to track the sun as the earth rotates in order to maximize the collection of solar energy.

Currently solar energy concentrator has a plurality of solar panel, which can be adjusted to face the sunbeams according to the direction and intensity of the sunbeams, for collecting the solar energy and converting the solar energy to the electrical potential energy for accumulation. Thus, in the current solar energy concentrator, a solar panel, a solar energy concentrator and a tracking element are necessary elements for assuring a good solar energy concentrating efficiency.

Various solar energy collection arrangements have been designed which employ a solar panel or a solar concentrating element fixed on a fastening element. The solar energy collection arrangements are horizontally or inclined fixed on a roof of a building or the ground by the fastening element. However, the fastening element maintains a fixed angle relative to the roof of a building or the ground. The solar energy collection arrangements can not track the sun and maximize the collection of solar energy as the earth rotates.

As shown in Taiwan Patent publication No. M284858, a solar energy concentrating structure for preventing typhoon is disclosed. The solar energy concentrating structure has a solar energy collator supporting member and a pedestal. The pedestal has an elevator and a pivot device. The elevator has a main body, a screw fixed on the main body, a movable body movably screwed on the screw. The movable body has a rotatable wheel. When the rotatable wheel is rotated, the movable body can move up and down because a screw thread of the movable body is rotated relative to the screw. The solar energy collator supporting member is fixed on the movable body at one end and pivotally connects with the pivot device at another end. The solar energy concentrating structure can be adjusted to different positions through the cooperation of the movable body and the pivot device. However, the solar energy concentrating structure needs manual orientation and can not automatically detect sunbeams. Therefore, the solar energy concentrating structure can not realize the automatically control, which is seldom properly oriented, with the result that energy collection is only occasionally conducted at maximum efficiency. In addition, the solar energy concentrating structure is inconveniently in operation.

Accordingly, what is needed is an automatically solar energy tracking and collecting system that can overcome the above-described deficiencies.

### BRIEF SUMMARY

Accordingly, the present invention is to provide automatically solar energy tracking and collecting system, in which a solar energy concentrator, is sensitive to solar radiation, is oriented to face the sun and to change orientation to track the sun in order to maximize the collection of solar energy.

An exemplary automatically solar energy tracking and collecting system is disclosed, which has a solar energy concentrator and a pedestal for supporting and locating the solar energy concentrator. The pedestal has at least one universal joint connecting with the solar energy concentrator; at least one supporting shaft engaging with the at least one universal joint; at least one photo sensor for detecting the direction and position of sunbeams; and a pump driving the at least one supporting shaft to expand or contract according to the detecting signal from the at least one photo sensor. The at least one supporting shaft cooperates with the at least one universal joint to adjust the position and angle of the solar energy concentrator relative to a predetermined reference surface.

Each universal joint includes an external bearing tube, an inner bearing seat fixed in the external bearing tube, a ball bearing accommodated in the external bearing tube and engaged with a concave socket of the inner bearing seat. The external bearing tube is fixed on the solar energy concentrator.

Other advantages and novel features will become more apparent from the following detailed description when taken in conjunction with the accompanying drawings.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a schematic, assembly view of an automatically solar energy tracking and collecting system according to a first embodiment of the invention;

FIG. 2 is a side elevation view of the automatically solar energy tracking and collecting system of FIG. 1;

FIG. 3 is an another side elevation view of the automatically solar energy tracking and collecting system of FIG. 1;

FIG. 4 is a partly schematic view showing an assembly of a universal joint and a solar energy concentrator of the automatically solar energy tracking and collecting system of FIG. 1;

FIG. 5 is an exploded, isometric view of the universal joint of FIG.4; and

FIG. 6 and FIG.7 show the automatically adjustment operation of the automatically solar energy tracking and collecting system.

### DETAILED DESCRIPTION

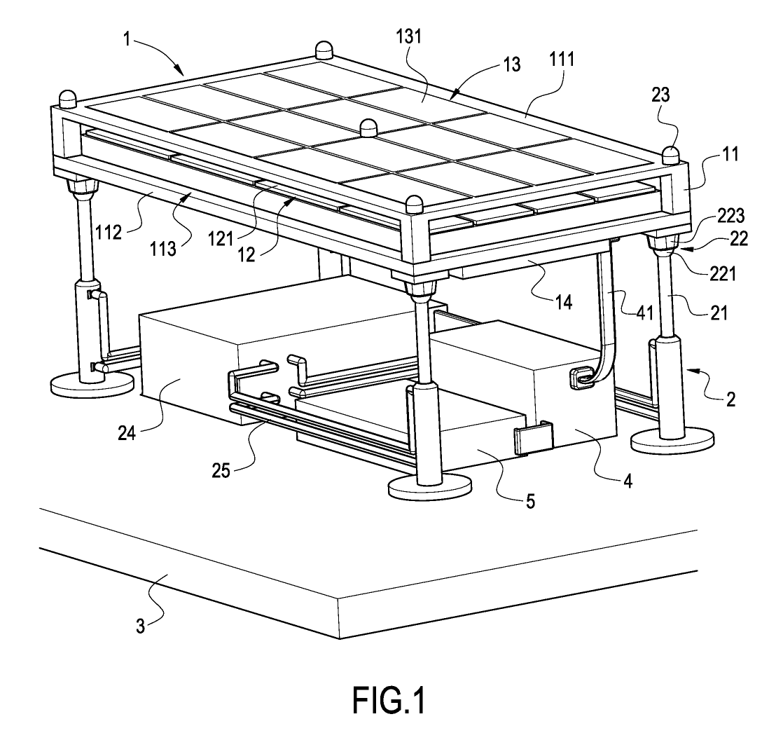

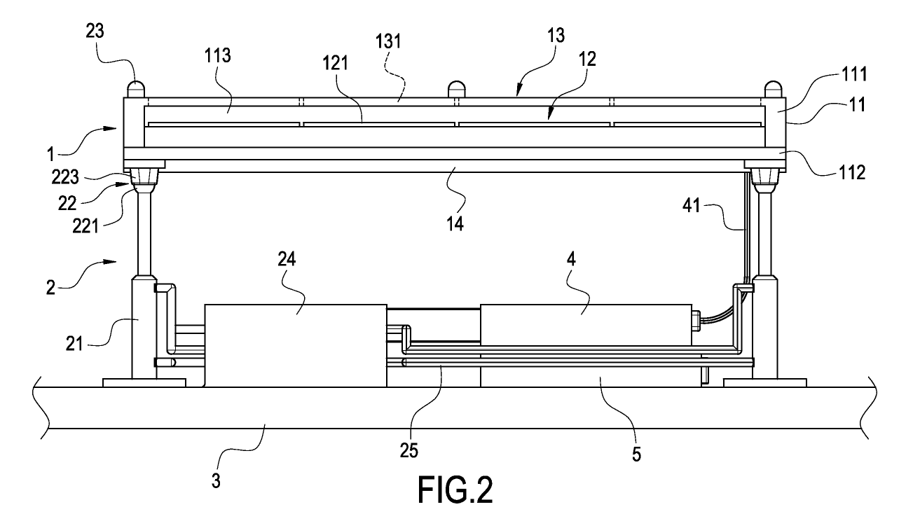

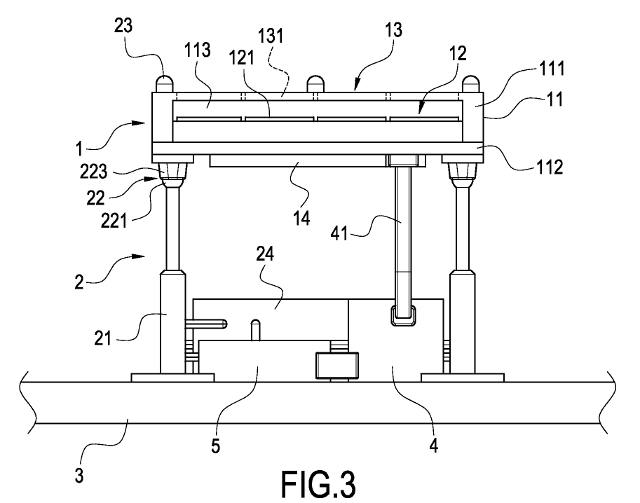

Referring to FIGS. 1-3, an automatically solar energy tracking and collecting system according to a first embodiment of the present invention is shown. The automatically solar energy tracking and collecting system has a solar energy concentrator 1 and a pedestal 2 for supporting and locating the solar energy concentrator 1.

The solar energy concentrator 1 has a solar panel 12, a solar energy concentrating plate 13, a supporting member 11, an incubator plate 14, a converter 4, a power accumulator 5. The supporting member 11 supports the solar panel 12 and the solar energy concentrating plate 13, which is fixed on the pedestal 2.

The supporting member 11 has an upper supporting frame 111 and a lower supporting plate 1 12. The upper supporting frame 111 is fixed on the lower supporting plate 112 spacing a special distance to form a space 113 therebetween. The space 113 is a through hole for atmospheric ventilation and heat dispersion.

The solar panel 12 has a plurality of solar cells 121 arranged in a matrix. The plurality of solar cells 121 is uniformly distributed on the lower supporting plate 112. The incubator 14 is disposed under the solar panel 12 for dispersing heat.

The solar energy concentrating plate 13 has a plurality of concentrating elements 131 arranged in a matrix, which the concentrating elements 131 are fixed on the upper supporting frame 111. The concentrating elements 131 are lens made from glass or acryl, having a predetermined curvature. Each of the concentrating elements 131 is corresponding to a solar cell 121 for efficiently concentrating sunbeams to the solar cell 121.

The converter 4 and the power accumulator 5 are disposed under the solar panel 12. The converter 4 electrically connects with the solar panel 12 through a flexible printed circuit board (FPCB) 41, for converting the heat energy and optical energy concentrated in the solar panel 12 to the electrical potential energy, and accumulates the electrical potential energy into the power accumulator 5.

The pedestal 2 has a base 3, a plurality of supporting shafts 21, a plurality of photo sensors 23, a plurality of universal joints 22, and a pump 24. The base 3 is used to locate the automatically solar energy tracking and collecting system on a roof of a building or the ground for balanced locating the automatically solar energy tracking and collecting system.

The supporting shaft 21 is a pressure expansion link, which is driven by hydraulic pressure or air pressure to expand or contract in a vertical direction. The supporting shaft 21 holds the supporting member 11. One end of the supporting shaft 21 is fixed on the base 3, and the other end of the supporting shaft 21 engages with the lower supporting plate 112 of the supporting member 11 through one universal joint 22. Preferred, the supporting shaft 21 is disposed respect to four corners of the lower supporting plate 112.

The plurality of photo sensors 23 is disposed on the upper supporting frame 111 of the supporting member 11 for detecting the direction and position of sunbeams, which is located corresponding to the supporting shaft 21. The photo sensors 23 have a number same to or more than that of the supporting shaft 21.

The pump 24 is a hydraulic pump or pneumatic pump, which connects with the supporting shafts 21 through a plurality of pipes 25, respectively. The pump 24 has a controller (not shown), which can judges and calculates the direction and angle degree region of the sunbeams according to detecting signals from the photo sensors 23, and drives the plurality of supporting shafts 21 to expand or contract in the vertical direction through outputting a different pressure, respectively. The pump 24 can be driven by an outer power supply or the electrical power stored in the power accumulator 5.

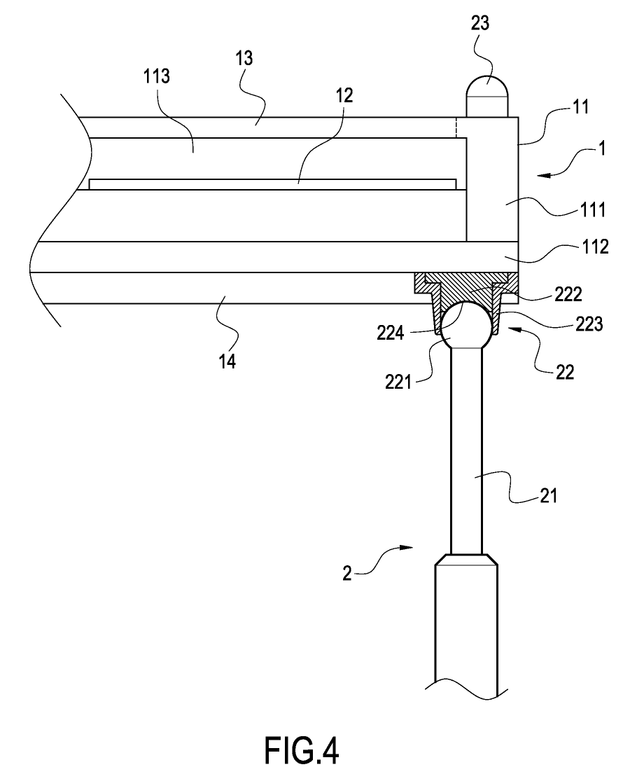

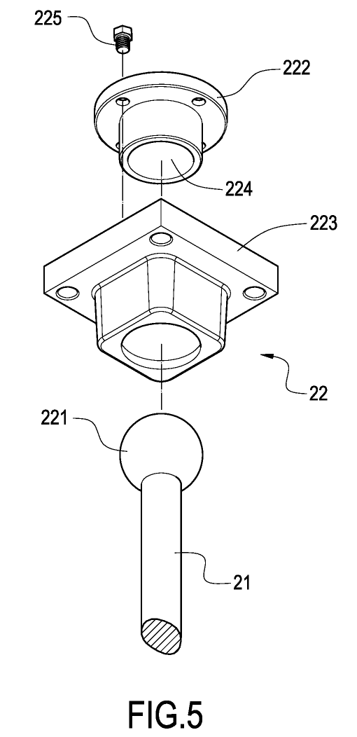

Referring to FIG. 4 and FIG. 5, the universal joint 22 has a ball bearing 221, an inner bearing seat 222, and an external bearing tube 223. The inner bearing seat 222 is fixed in the external bearing tube 223 through a fastening element 225. The fastening element 225 may be screw. The ball bearing 221 connecting with the other end of the supporting shaft 21 is accommodated in the external bearing tube 223 and engages with a concave socket 224 of the inner bearing seat 222. The external bearing tube 223 is fixed on the lower supporting plate 112 of the supporting member 11 by screws, through which the supporting member 11 can be angular adjusted relative to the supporting shaft 21.

In assembly, the solar energy concentrator 1 is fixed on the pedestal 2 by the connection of the lower supporting plate 112 of the supporting member 11 and the supporting shaft 21. The lower supporting plate 112 connects with the supporting shaft 21 through a universal joint 22. The lower supporting plate 112 spaces with the upper supporting frame 111 of the supporting member 1 and defines the space 113 therebetween. The solar energy concentrating plate 13 is engaged on the upper supporting frame 111 and the solar panel 12 is disposed on the lower supporting plate 112. Each of the concentrating elements 131 of the solar energy concentrating plate 13 faces one solar cell 121 of the solar panel 12. In addition, the plurality of photo sensor 23 is set on the upper supporting frame 111 of the supporting member 11 for detecting sunbeams, respect to four corners of the upper supporting frame 111.

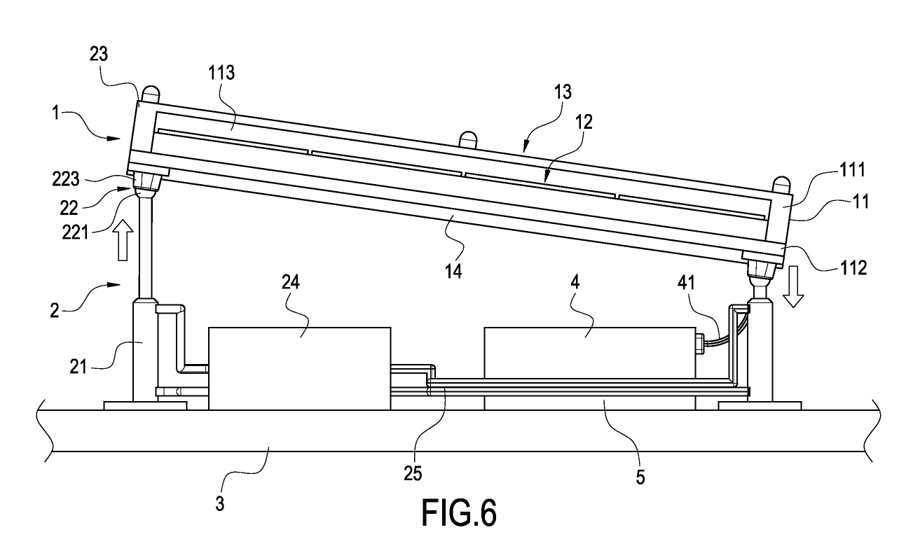

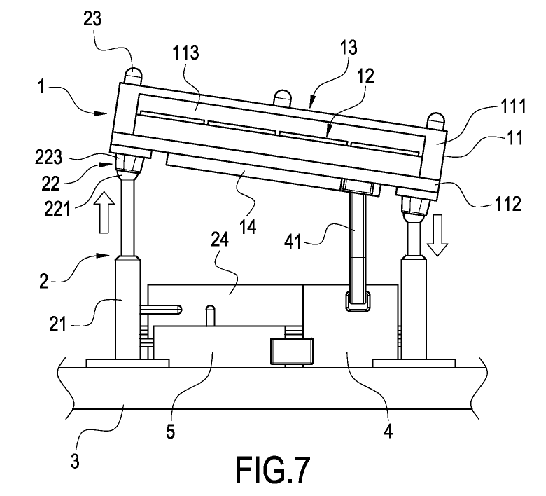

In operation, when the photo sensors 23 detect the direction and intensity of the sunbeams, the photo sensors 23 produces different pulse signals or detecting signals to the controller of the pump 24 according the intensity of the sunbeams from different direction. The pump 24 judges and calculates the direction and angle degree region of the sunbeams according to different pulse signals from the photo sensors 23, and drives the plurality of supporting shafts 21 to expand or contract a different levels in the vertical direction, respectively. As shown in FIG. 6, the supporting member 11 is adjusted front and rear. As shown in FIG. 7, the supporting member 11 is adjusted right and left. At the same time, when the supporting shaft 21 expands or contracts in the vertical direction, the supporting shaft 21 cooperates with the universal joint 22 to apply an angular adjustment of the lower supporting plate 112 of the supporting member 11. Accordingly, the solar energy concentrating plate 13 and the solar panel 12 on the supporting member 11 are adjusted to face the sunbeams through the cooperation of the plurality universal joints 22 and the plurality of supporting shafts 21. Each of the concentrating elements 131 of the solar energy concentrating plate 3 concentrates sunbeams to a corresponding solar cell 121 of the solar panel 12. The converter 4 converts the heat energy and optical energy concentrated in the solar panel 12 to the electrical potential energy, and transmits the electrical potential energy into the power accumulator 5 to accumulate. The space 113 between the lower supporting plate 112 and the upper supporting frame 111, and the incubator plate 14 attached on the solar panel 12 efficiently disperses the heat produced in the process of the solar panel 12 absorbing optical energy and heat energy of sunbeams.

Because the automatically solar energy tracking and collecting system utilizes the cooperation of the plurality of universal joints 22, the plurality of supporting shaft 21 and the plurality of photo sensors 23 to realize automatically solar energy tracking and collecting, in which the concentrator, sensitive to solar radiation, is oriented to face the sun and to change or orientation to track the sun as the earth rotates in order to maximize the collection of solar energy.

The above description is given by way of example, and not limitation. Given the above disclosure, one skilled in the art could devise variations that are within the scope and spirit of the invention disclosed herein, including configurations ways of the recessed portions and materials and/or designs of the attaching structures. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. An automatically solar energy tracking and collecting system, comprising:
a solar energy concentrator; and
a pedestal for supporting and locating the solar energy concentrator, the pedestal comprising:
at least one universal joint connecting with the solar energy concentrator;
at least one supporting shaft engaging with the at least one universal;
at least one photo sensor for detecting direction and intensity of sunbeams; and
a pump driving the at least one supporting shaft to expand or contract according to a detecting signal from the at least one photo sensor,
wherein the at least one supporting shaft cooperates with the at least one universal joint to adjust location and angle of the solar energy concentrator relative to a predetermined referent surface.

2. The automatically solar energy tracking and collecting system as claimed in claim 1, wherein the pedestal further comprises a base, the at least one supporting shaft being fixed thereat.

3. The automatically solar energy tracking and collecting system as claimed in claim 1, wherein each supporting shaft is a pressure expansion link driven by hydraulic pressure or air pressure to expand or contract.

4. The automatically solar energy tracking and collecting system as claimed in claim 1, wherein the universal joint comprises an external bearing tube, an inner bearing seat fixed in the external bearing tube, a ball bearing accommodated in the external bearing tube and engaged with a concave socket of the inner bearing seat, the external bearing tube being fixed on the solar energy concentrator.

5. The automatically solar energy tracking and collecting system as claimed in claim 4, wherein a number of the photo sensor is more than or same as that of the supporting shaft, and the at least one photo sensor is located according to the at least one supporting shaft.

6. The automatically solar energy tracking and collecting system as claimed in claim 1, wherein the pump is a hydraulic pump or pneumatic pump, which connects with the at least supporting shaft through at least one pipe.

7. The automatically solar energy tracking and collecting system as claimed in claim 1, wherein the pump has a controller, which judges and calculates the direction and angle of the sunbeams according to outputting signals from the at least one photo sensor, and drives the at least one supporting shaft to expand or contract in the vertical direction through outputting a different pressure.

8. The automatically solar energy tracking and collecting system as claimed in claim 1, wherein the pump is driven by an outer power supply.

9. The automatically solar energy tracking and collecting system as claimed in claim 1, wherein the solar concentrator comprises a solar panel comprising a plurality of solar cells; a solar energy concentrating plate comprising a plurality of concentrating elements, each of the concentrating elements facing a solar cell; and a supporting member supporting the solar panel and the solar energy concentrating plate, the solar energy concentrating plate concentrating sunbeams to the solar panel.

10. The automatically solar energy tracking and collecting system as claimed in claim 9, wherein the supporting member comprises an upper supporting frame and a lower supporting plate, the lower supporting plate supporting the upper supporting frame.

11. The automatically solar energy tracking and collecting system as claimed in claim 10, wherein the supporting member includes a through hole between the upper supporting frame and the lower supporting plate.

12. The automatically solar energy tracking and collecting system as claimed in claim 10, wherein the upper supporting frame and the lower supporting plate space a special distance to form a space therebetween.

13. The automatically solar energy tracking and collecting system as claimed in claim 12, wherein the space is a through hole.

14. A solar energy concentrator as claimed in claim 10, wherein the solar panel is formed on the lower supporting plate, and the solar energy concentrating plate is fixed on the upper supporting frame.

15. The automatically solar energy tracking and collecting system as claimed in claim 9, further comprising an incubator plate attached to the solar panel.

16. The automatically solar energy tracking and collecting system as claimed in claim 9, further comprising a converter and a power accumulator, the converter electrically connecting with the solar panel through a flexible printed circuit board (FPCB), for converting heat energy and optical energy concentrated in the solar panel to electrical potential energy, and accumulating the electrical potential energy into the power accumulator.

17. The automatically solar energy tracking and collecting system as claimed in claim 16, wherein the pump is driven by the power accumulator.
